(19) United States
(12) Patent Application Publication
(10) Pub. No.: US 2007/0218926 A1
(43) Pub. Date: Sep. 20, 2007

(54) SYSTEM AND METHOD FOR HANDLING MOBILE STATION LOCATION UPDATE

(75) Inventors: Hongcheng Zhuang, Shenzhen (CN); Yi Song, Shanghai (CN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Huawei Technologies Co., Ltd., Shenzhen (CN)

(21) Appl. No.: 11/685,150

(22) Filed: Mar. 12, 2007

Related U.S. Application Data
(63) Continuation of application No. PCT/CN06/02999, filed on Nov. 9, 2006.

(30) Foreign Application Priority Data
Feb. 16, 2006 (CN) 200610003140.X
Mar. 10, 2006 (CN) 200610057351.1

(51) Int. Cl. H04Q 7/20

(52) U.S. Cl. 455/466

(57) ABSTRACT

The present invention relates to WiMAX communication technology, and particularly relates to a method and a system for handling Mobile Station location update in a WiMAX system, in order to solve the problems in the existing technology that a Paging Controller cannot perform a corresponding process based on the location update type of the Mobile Station, which results in location update low success rate. In the aforesaid technical proposal of the present invention, when a Paging Agent performs location update in a Mobile Station, it sends a location update request to a Paging Controller, and the location update request carries information indicating the Mobile Station location update type; after the Paging Controller successfully performs location update in the Mobile Station, it performs the corresponding process to the information indicating the location update type. The said location update type information is indicated through a corresponding flag bit set in the relevant message or an optional information unit.

### CROSS-REFERENCES TO RELATED APPLICATIONS

This application is a continuation of the PCT Application No. PCT/CN2006/002999, filed Nov. 9, 2006, which is incorporated by reference herein for all purposes. The PCT Application No. PCT/CN2006/002999 claims priority from Chinese Patent Application No. 200610003140.X, filed Feb. 16, 2006, and Chinese Patent Application No. 200610057351.1, filed Mar. 10, 2006, both of which are incorporated by reference herein for all purposes. Additionally, this application claims priority to Chinese Patent Application No. 200610057351.1, filed Mar. 10, 2006, which is incorporated by reference herein for all purposes.

### STATEMENT AS TO RIGHTS TO INVENTIONS MADE UNDER FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK.

Not Applicable

### BACKGROUND OF THE INVENTION

The present invention is related to WiMAX (Worldwide Interoperability for Microwave Access) communication technology, and particularly is related to a system and a method for handling mobile station location update.

Prior Art

WiMAX is an up and coming wireless communication technology. It has the capability to provide a high-speed internet connection. As shown in FIG. 1, in the current WiMAX communication system, MS's (Mobile Station) paging and idle mode processing include the following functional entities:
1. PC (Paging Controller): A PC decides MS's behavior during idle mode in a network, each PC functional entity defines a unique identification information PC ID (6 bytes), and this parameter will indicate the address of one PC functional entity; PCs are connected through a R4 interface;
2. PA (Paging Agent): PA is a functional entity for resolving interaction between the PC and the related paging functional entity in a BS (Base Station) as defined in IEEE802.16e, and PA is located above BS;
3. PG (Paging Group): A BS is divided into many logical groups. For example, PGA includes PA0, PA1; PGB includes PA2; and PGC includes PA3, PA4 and PA5. The purpose of these paging groups is to provide an adjacent area, where MS does not need to transmit LU (Location Update) message in this area, and it can receive DL (Down Link) paging. The Paging Group should be large enough so that MS is held in the same Paging Group most of the time, and it should be small enough to reasonably distribute paging load.
4. LR (Location Register): LR is a distributed database, each LR corresponds to a PC, and the LR contains MS information in idle mode. This information includes the current Paging Group identification (PG ID), paging cycle (PAGING_CYCLE), Paging offset (PAGING_OFFSET), the updated BS ID, updated relay PC ID and MS service flow information.

When a MS is in IDLE (idle) state, it will send a RNG-REQUEST (ranging request) message to a BS based on different conditions, in order to trigger the PA to send a LU message. These conditions include the following four types:
1. Paging Group update: When the MS detects a change of the Paging Group it belongs to, the MS will execute the Location Update process. The MS judges there is a change of the Paging Group through monitoring PG ID, and this PG ID is transmitted by BS through the DCD (Downlink Channel Descriptor)) message or MOB PAG ADV (Mobile Paging Advertisement) message during MS paging monitor interrupt time. If the MS detects PG ID and the MS currently belonging to the Paging Group mismatch, then the MS knows the Paging Group has changed;
2. Timer update: The MS periodically runs the Location Update process before resetting the idle mode timer, which periodically triggers the PA sending a LU message to the PC, to notify the PC currently is in idle state. When the PC has not received a periodical LU message, it decides that the MS status has changed, then the relevant idle mode information of the MS can be deleted;
3. Power Down Update: The MS will attempt to finish a Location Update process as a part of the shutdown process. This mechanism allows the Paging Controller to update the current status of the MS, delete all information relevant to the MS, and terminate idle mode paging control to this MS at the time of shutdown. Under the conditions of a successful update power-off location update, the PC will release all MS idle mode information held by the MS. Under the conditions of a failed power-off location update, the PC will use Location Update polling to execute availability detection. If the BS repeatedly sends Location Update polling message in a preset number of times and no response is received, this MS is detected as unusable. The PC then detects all idle mode information held by this MS;
4. MAC Hash Skip Threshold update: When MAC Hash Skip Timer of the MS exceeds MAC Hash Skip Threshold, the MS will execute the location update process. Once location update is successful, the BS and the MS will re-initialize their respective MAC Hash Skip Timer.

The existing WiMAX location update process triggered by one of the above described conditions is shown in FIG. 2, includes the following steps:

1. If one of the above described four conditions is satisfied, then the MS will initialize a location update process, and send a ranging request (RNG Request) message. The destination field in the RNG-REQUEST message must be set to the MS location update execution destination defined by IEEE802.16e, these include: LU Flag identification, that indicates this RNG Request message is triggered by the mobile station location update; it also includes trigger type information, that indicates the location update type for triggering this RNG Request message; it also must include the PC ID, that this PC ID is the anchor paging controller (Anchor PC) identification of the current MS;

2. After the PA receives the RNG Request message from the MS, it sends a LU Request (Location Update Request) message to the PR (Paging Relay); the LU Request message must include MS ID, BS ID, and PC ID. The specific information is shown in Table 1 below:

TABLE 1
LU Request message

| Information | | Forced or | |
|---|---|---|---|
| elements | Description | Optional | Remarks |
| MS ID | MS's MAC | Forced | This identification is used for |
| | address | | indicating the request sending MS |
| BS ID | Base station | Forced | BS ID indicates the BS on which |
| | identification | | the MS was executing location |
| | | | updating |
| PC ID | PC identification | Forced | PC ID indicates MS's paging |
| | (for example, IP | | controller (Anchor PC) |
| | address) | | |
| Relocation_Dest_ID | Relocation | Optional | Identification of the intended |
| | destination | | relocation Anchor PC |
| | identification | | |

3. After the Paging Relay receives the LU Request message, it sends the LU Request message to the Anchor PC based on the PC ID carried in this message, and this LU Request message also must include MS ID and BS ID;

4. The Anchor PC assigns a new PG ID and sends a LU Response (Location Update Response) message to the Paging Relay, and this LU Response message must include the MS ID, BS ID, the new PG ID, the Authenticator ID and PC ID of the Anchor Authenticator, and the specific contents are as shown in Table 2 below:

TABLE 2
LU Response message contents

| Information | | Forced or | |
|---|---|---|---|
| elements | Description | optional | Remarks |
| MS ID | MS's MAC address | Forced | This identification is only |
| | | | the sending request MS |
| BS ID | Base station | Forced | BS ID indicates the BS on |
| | identification | | which the MS executes |
| | | | location update |
| PG ID | Paging group | Forced | |
| | identification-The MS | | |
| | assigned paging group | | |
| PC ID | PC identification (for | Forced | PC ID is only the MS's |
| | example, IP address) | | paging controller |
| MS Security | AKID, AK, PN, AK | Forced | The security context that |
| Context | lifetime | | BS needs for enabling the |
| | | | RNG-REQUEST message. |
| Relocation_Response | (Boolean variable) | Optional | “Accept” or “Refuse” |
| | response relocation | | |
| MS Data | The old Anchor PC | Optional | Attention, if any field |
| Structure | needs to pass | | above is “Refuse”, this |
| | information to the new | | field can be ignored. |
| | Anchor PC. | | |

5. LU Response message is forwarded to PA by Paging Relay

After the PA's BS receives the LU Response message, it first decides whether there is an available AK (Authentication Key) corresponding to this MS ID from the MS current anchor Authenticator. If there is no corresponding available AK, the PA's BS sends an AK request message (not shown in this diagram) to the Anchor Authenticator. The Anchor Authenticator returns an AK response (not shown in the diagram), and provides an AK serial number for a secure connection between BS and MS;

6. The PA's BS uses the AK to verify integrity and accuracy of the RNG Request message from MS. If the MS's RNG Request message passes verification, then the BS will reply a RNG Response (Ranging Response) message to the MS and the RNG Response message carries the newly assigned PG ID. If RNG Request fails to pass verification, then the BS starts the Un-secure Location Update process through initializing re-authentication;

7. If the RNG_REQUEST message passes verification, the PA sends a LU Confirm (Location Update Confirmation) message to Paging Relay. This LU Confirm message must contain MS ID, BS ID, and authentication success indication, to indicate Location update from MS has already been authenticated and the process has finished successfully. The specific LU Confirm message is as shown in Table 3 below:

| Information | | Forced or | |
|---|---|---|---|
| elements | Description | optional | Remarks |
| MS ID | MS's MAC address | Forced | This identification is only |
| | | | the request-sending MS |
| BS ID | Base station | Forced | BS ID indicates the BS on |
| | identification | | which the MS was |
| | | | executing the location |
| | | | update |
| PC ID | PC identification (for | Forced | PC ID is only the MS's |
| | example, IP address) | | paging controller |
| LU Success/ | Location update success | Forced | |
| Failure | or failure indication | | |
| Indicator | | | |
| Relocation_Response | Security context update | Forced | May use |
| | | | MS_Security_Context |
| Relocation | (Boolean variable) | Optional | |
| Success | indicates whether or not | | |
| Indicator | this re-location will be | | |
| | accepted, and finished | | |
| | by the relocation | | |
| | destination | | |

8. The Paging Relay transmits this LU Confirm message to the Anchor PC. After the Anchor PC receives the LU Confirm message, it then finally updates MS's location in the LR.

As can be seen in the above described update process, it is impossible for PC to know what type of condition will trigger an update. Therefore, the PC cannot execute processes according to different conditions. This results in some failures in the location update process.

### BRIEF SUMMARY OF THE INVENTION

The present invention provides a method and a system for handling mobile station location update. It attempts to solve the problems in the existing technology of the paging controller being unable to perform such a corresponding processing method based on the location update type of the mobile station. This has resulted in a low success rate for location updates.

A processing method for mobile station location update in a type of WiMAX system includes the following steps:

As a Mobile station is undergoing a location update, a Paging Agent sends a location update request to a Paging Controller. This location update request carries information indicating the Mobile Station location update type; after the Mobile Station location update is successful, the Paging Controller performs the corresponding process according to the information indicating the location update type.

In the above described method, the Mobile Station sends a ranging request for performing location update to the Paging Agent when performing location update, and this ranging request carries information indicating the location update type; after the Paging Agent receives said ranging request, it sends a location update request to the Paging Controller through a Paging Relay, and this location update request carries information of said indicated location update type.

Preferably, according to the above described method of the present invention, the Paging Controller assigns a Paging Group for the Mobile Station, after receiving said location update request, and then returns location update response to the Paging Agent through the Paging Relay; this location update response carries information indicating the location update type and information of the assigned Paging Group identification;

The Paging Agent sends a ranging response message carrying said Paging Group identification information, and sends location update confirmation to the Paging Controller through the Paging Relay;

After the Paging Controller receives the location update, the corresponding process is executed according to the locally recorded information indicating the Mobile Station location update type.

According to the above described method of the present invention, the above described location update type information is indicated through the corresponding flag bit set in the relevant message received in the location update process.

The above described location update type at least includes one of the following: location update triggered by Paging Group update, location update triggered by timer update, location update triggered by Power Down Indicator, location update triggered by MAC Hash Skip Threshold.

Or, referencing the existing ranging message, the said location update type information can be indicated through adding optional information unit in the message used in the location update process.

Among them, the said location update type includes location update triggered by Power Down Indicator. Also, the said optional message unit includes the location update 1st message unit triggered by indication of the Power Down Indicator.

The said location update type includes the location update triggered by MAC Hash Skip Threshold, and the said optional message unit includes the location update 2nd message unit triggered by indication of the MAC Hash Skip Threshold.

The said location update type also includes: location update triggered by Paging Group update and/or location update triggered by timer update. Also, when all optional message units are entirely empty, the Paging Controller decides whether the base station that the Mobile Station currently belongs to is included in the Paging Group of this Mobile Station; if it is, then it is the location update triggered by the timer update; otherwise it is the location update triggered by Paging Group update.

Or, the said location update type also includes the location update triggered by Paging Group update. Additionally, the said optional message unit includes a 3rd message unit of the location update triggered by Paging Group update; and/or the said location update type also includes the location update triggered by the timer update. In addition, the said optional message unit includes a 4th message unit of the location update triggered by indication of timer update.

The present invention also provides a system for handling Mobile Station location update in a WiMAX system, including a Mobile Station, a Paging Agent and a Paging Controller. The said Paging Agent sends a location update request to the Paging Controller when said Mobile Station performs location update, and the location update request carries a message indicating the Mobile Station location update type. The said Paging Controller performs the corresponding process based on the said message indicating the location update type, after the said Mobile Station location update is successful.

Furthermore, the said system also includes a Paging Relay. The said Mobile Station sends a ranging request for execution location update to the Paging Agent upon performing location update, and the ranging request carries a message indicating the location update type; after the said Paging Agent receives the said ranging request, it sends a location update request to the Paging Controller through the said Paging Relay, and the location update request carries a message indicating the location update type.

Preferably, the said Paging Controller includes a first assignment module and a first processing module. Upon the said first assignment module receiving the said location update request for assigning a Paging Group for the Mobile Station, and returning a location update response to the Paging Agent through the Paging Relay, the location update response carries information indicating the location update type and the assigned Paging Group flag information;

The said Paging Agent sends a ranging response message carrying the said Paging Group flag information to the said Mobile Station, and it sends a location update confirmation to the Paging Controller through the said Paging Relay. The location update confirmation includes the said information indicating the location update type;

Upon the said first processing module receiving the said location update confirmation, the corresponding process is performed according to the carried information indicating location update type.

Preferably, the said Paging Controller includes: a second assignment module, a storage module, and a second processing module;

Upon the said second assignment module receiving the said location update request, it records the information indicating the location update type and stores it to the said storage module. The said second assignment module then assigns a Paging Group for the said Mobile Station, and returns a location update response to the Paging Agent through the said Paging Relay. The location update response then carries the assigned Paging Group flag information;

The said Paging Agent sends a ranging response message carrying the said Paging Group flag information to the said Mobile Station, and it sends a location update confirmation to the Paging Controller through the said Paging Relay;

Upon the said second processing module receiving the said location update confirmation, it performs the corresponding process according to the information indicating the Mobile Station location update type recorded in the said storage module.

The beneficial effects of this invention include the following:

In the said technical proposal of the present invention, through extending the LU Request message, LU Response message, and LU Confirm message for carrying location update type information, this invention helps to optimize the processing flow in the location update process, which allows the Anchor PC able to confirm the current location update type and perform the corresponding process according to the location update type. This results in an improved location update success rate.

Moreover, with the technical proposal of the present invention, the location update type information is carried only through extending the LU Request message. In this invention, the Anchor PC records the MS's current location update type in the processing procedure, and performs the corresponding process according to the location update type. This also improves location update success rate.

### BRIEF DESCRIPTION OF THE DRAWINGS

FIG. 1 is a schematic diagram of the functional entity connections including MS paging and idle mode operations in the current WiMAX communication system;

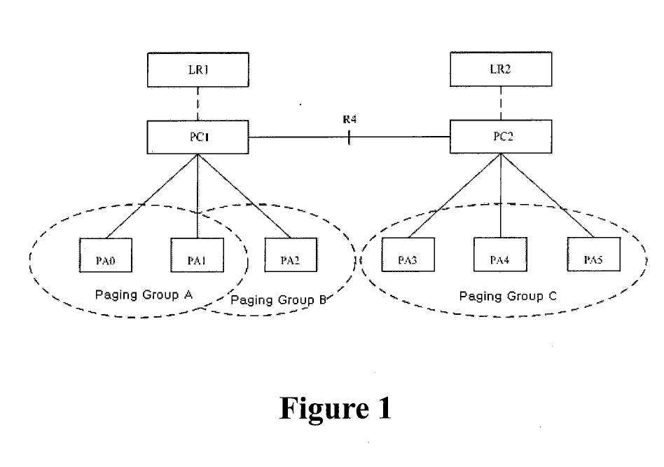

FIG. 2 is a schematic diagram of the existing location update flow;

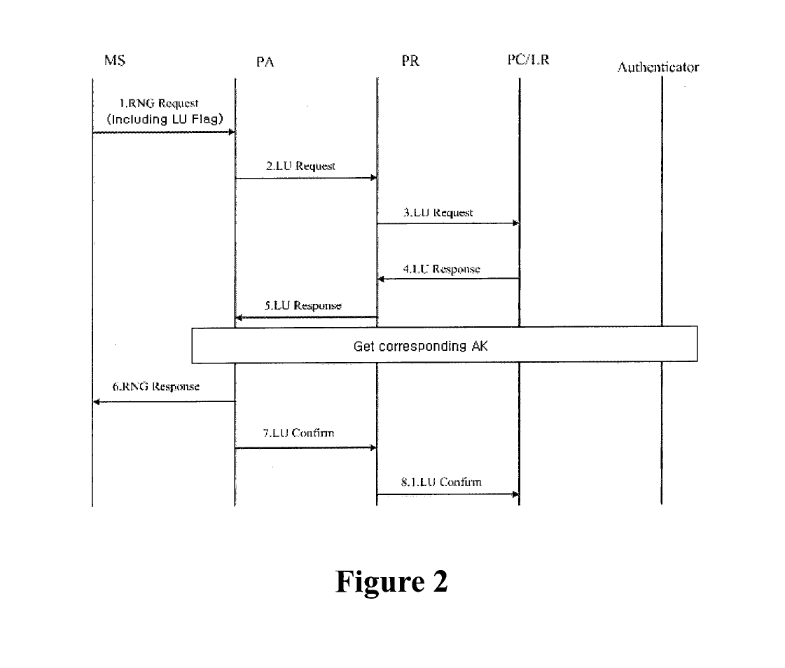

FIG. 3 is a schematic diagram of the main flow of the said location update processing method of application example 1 of the present invention;

FIG. 4 is a schematic diagram of the main flow of the said location update processing method of application example 2 of the present invention;

FIG. 5 is a schematic diagram of the main structure of the said location update processing system in the application example of the present invention;

FIG. 6 and FIG. 7 are schematic diagrams showing a specific configuration of the location update processing system.

### DETAILED DESCRIPTION OF THE INVENTION

Specific Implementation Modes

The specific implementation examples are described in details with reference to the diagrams in the following.

### APPLICATION EXAMPLE 1

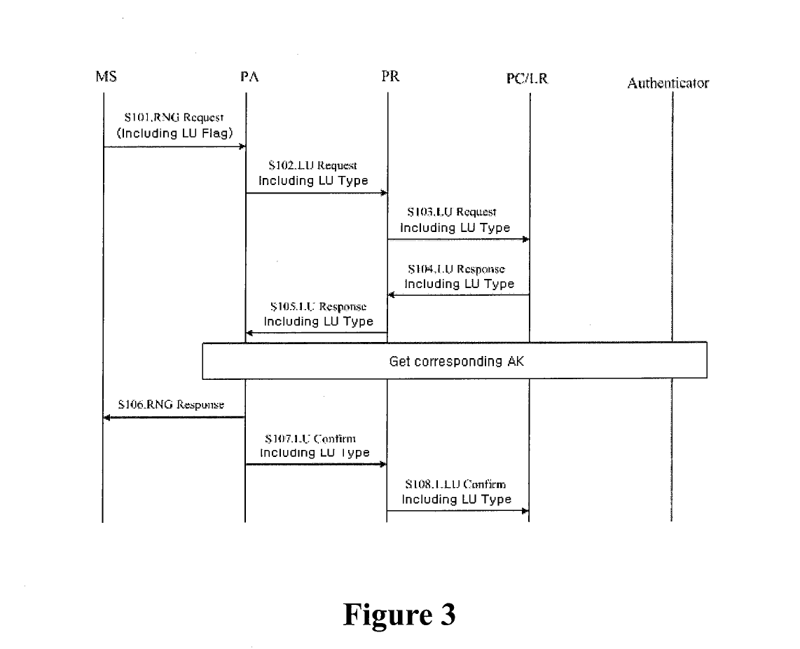

In Application example 1 of the present invention, a LU Type flag bit carrying triggering condition identification information is set up in the LU Request message, the LU Response message, and the LU Confirm message; and the PC performs a corresponding process according to the LU Type indicating the triggering condition type. The specific implementation mode is shown in FIG. 3, which includes the following steps:

S101: If either one of the four conditions for triggering location update is satisfied, then MS will initialize a location update process and send a RNG Request message carrying LU Flag to the BS;

In the existing protocol, the RNG Request message contains a MAC Hash SkipThreshold field and a Power Down Indicator field indicating the location update type, which indicates whether or not to update MAC Hash Skip Threshold or Power Down at the present time. The RNG Request message also contains a BS ID field, which is used to indicate the BS that the MS currently belongs to;

S102: Upon the PA on the BS receiving MS's RNG Request message, it confirms the triggering condition type based on the contents therein;

If the MAC Hash Skip Threshold field is being set, which indicates the current type is MAC Hash Skip Threshold update;

If the Power Down Indicator field is being set, which indicates the current type is Power Down update;

If both fields are empty, then PA cannot judge whether it is Paging Group update or Timer update.

The PA sets the corresponding LU Type flag bit in the LU Request message sent to PR, the LU Request message also must contain MS ID, BS ID, and PC ID. Based on the judgment results, the LU Type indicates the type of location update request can be distinguished using two bits at least, as shown in Table 4 below:

TABLE 4
LU Type flag bit

| | | | | | |
|---|---|---|---|---|---|
| 1. | Type | 2. | Flag bit (2 bit) | 3. | Description |
| 4. | Type 1 | 5. | 00 | 6. | Paging Group update or timer |
| | | | | | update |
| 7. | Type 2 | 8. | 01 | 9. | Power-off update |
| 10. | Type 3 | 11. | 10 | 12. | MAC Hash Skip Threshold |
| | | | | | update |

If the RNG Request message contains specific information for each type, then the PA can judge all update types; correspondingly, the LU Type flag bit can be set based on the following Table 5:

TABLE 5
LU Type flag bit

| 13. Type | 14. Flag bit (2 bit) | 15. Description |
|---|---|---|
| 16. Type 1 | 17. 00 | 18. Paging Group update |
| 19. Type 2 | 20. 01 | 21. Timer update |
| 22. Type 3 | 23. 10 | 24. Power-off update |
| 25. Type 4 | 26. 11 | 27. MAC Hash Skip Threshold update |

If the triggering condition type increases, then add LU Type flag bit accordingly.

The specific information contained in LU Request message after extension is as shown in the following Table 6:

TABLE 6
LU Request message content after extension

| | | Forced or | |
|---|---|---|---|
| Message elements | Description | optional | Remarks |
| MS ID | MS's MAC address | Forced | This flag is used for |
| | | | indicating the request-sending |
| | | | MS |
| BS ID | Base station flag | Forced | BS ID indicates the BS on |
| | | | which the MS was executing |
| | | | location update |
| PC ID | PC flag (for | Forced | BS ID indicates the BS on |
| | example, IP address) | | which the MS was executing |
| | | | location updating |
| LU Type | Location update | Forced | LU Type indicates the |
| | trigger type flag bit | | location update request type |
| Relocation_Dest_ID | Relocation target | Optional | Anchor PC flag when |
| | flag | | relocation is intended |

S103: Upon the Paging Relay receiving the LU Request message, it sends the LU Request message to the Anchor PC carrying the PC ID in the message;

S104: Upon the Anchor PC receiving the LU Request message, it judges the trigger type based on the information carried in the LU Type flag bit, sets the corresponding information in LU Type flag bit of the LU Response message, then sends the LU Response message to the Paging Relay. The LU Response message must contain the LU Type, MS ID, BS ID, PG ID, and Authenticator ID and PC ID of the Anchor Authenticator;

The specific content of the extended LU Response message is as shown in Table 7 below:

TABLE 7
The extended LU Response message content

| | | Forced or | |
|---|---|---|---|
| Information elements | Description | optional | Remarks |
| MS ID | MS's MAC address | Forced | This flag is only the |
| | | | request-sending MS |
| BS ID | Base station | Forced | BS ID indicates the BS on |
| | identification | | which the MS was |
| | | | executing location update |
| PG ID | Paging Group flag - the | Forced | |
| | Paging Group that was | | |
| | assigned to the MS | | |
| PC ID | PC identification (for | Forced | PC ID is only the MS's |
| | example, IP address) | | paging controller |
| LU Type | Location update trigger | Forced | The LU type indicates the |
| | type flag bit | | location update request |
| | | | type |
| MS Security Context | AKID, AK, PN, AK | Forced | Security context required |
| | lifetime | | by BS to enable RNG- |
| | | | REQUEST message |
| Relocation_Response | (Boolean variable) | Optional | “Accept” or “Refuse” |
| | response relocation | | |
| MS Data Structure | Information that the old | Optional | Attention, this field can be |
| | Anchor PC needs to | | ignored if any field above |
| | pass over to the new | | is “Refuse”. |
| | Anchor PC. | | |

S105: Paging Relay transmits the LU Response message to PA;

Once the BS, on which the PA is located, receives the LU Response, it first judges whether there is an available AK from the Anchor Authenticator corresponding to the MS ID. If there is no corresponding AK, the BS on which the PA is located will send an AK request message to the Anchor Authenticator. The Anchor Authenticator returns an AK response to provide an AK serial number used for establishing a secure connection between the BS and MS;

S106: The BS on which the PA is located uses AK to verify integrity and accuracy of the RNG Request message from the MS. If the MS's RNG Request message passes verification, then the BS will instruct the PA to respond to one MS RNG Response message, and the RNG Request message carries the newly assigned PG ID. If the RNG Request did not pass verification, then the BS starts Un-secure Location Update process through initializing re-authentication;

S107: If the RNG Request message passes verification, the PA sets the corresponding information in the LU Type flag bit in the LU Confirm message, and the LU Confirm message must contain LU Type, MS ID, BS ID, and authentication success indication. The authentication success indication is from the result that MS's location update has been authenticated and the process has been successfully finished;

The specific contents of the extended LU Confirm message is shown in Table 8 below:

TABLE 8
The extended LU Confirm message content

| Information | | Forced or | |
|---|---|---|---|
| elements | Description | optional | Remarks |
| MS ID | MS's MAC address | Forced | This flag is only the MS sent |
| | | | request |
| BS ID | Base station | Forced | BS ID indicates the BS on which |
| | identification | | the MS is executing location |
| | | | updating |
| PC ID | PC identification (for | Forced | PC ID is only the MS's paging |
| | example, IP address) | | controller |
| LU Type | Location update trigger | Forced | LU type indicates the location |
| | type flag bit | | update request type |
| LU | Location update | | |
| Success/Failure | success/failure | | |
| Indicator | indication | | |
| Security | Security context update | Forced | It may use MS_Security_Context |
| Context | | | |
| Update | | | |
| Relocation | (Boolean variable) | Optional | Target relocation successful |
| Success | indication of whether the | | |
| Indicator | relocation is being | | |
| | accepted and the | | |
| | relocation target is | | |
| | finished | | |

S108: The Paging Relay transmits the LU Confirm message to the Anchor PC; upon the Anchor PC receiving the LU Confirm message, LU Type flag bit is set to 00 if based on the setup method shown in Table 4. Then the Anchor PC judges whether the BS ID matches with the Paging Group information that the MS belongs to; if a match is found, then the location update was triggered by the Timer update; otherwise, the location update was triggered by Paging Group update. The Anchor PC executes the corresponding process based on the current location update type:

If the location update was triggered by Paging Group update, then update information in LR;

If the location update was triggered by timer update, then perform the corresponding process;

If the location update was triggered by power-off, then delete all idle mode information regarding that MS;

If the location update was triggered by MAC Hash Skip Threshold update, then perform the corresponding process, and the existing protocol will not establish a specific processing method.

In the above described application example, through extension of the LU Request message, LU Response message, and LU Confirm message to carry location update type information, this application enables the Anchor PC to confirm the current location update type, thereby improving the processing location update success rate.

### APPLICATION EXAMPLE 2

In order to attain the purpose of the application of the present invention, it is also possible to carry a flag information identifying the LU type only in the LU Request message. Also, the functional entities: PA, PC are needed to store the flag information after receiving the LU Request message, in order to perform the corresponding process after successfully finishing location update.

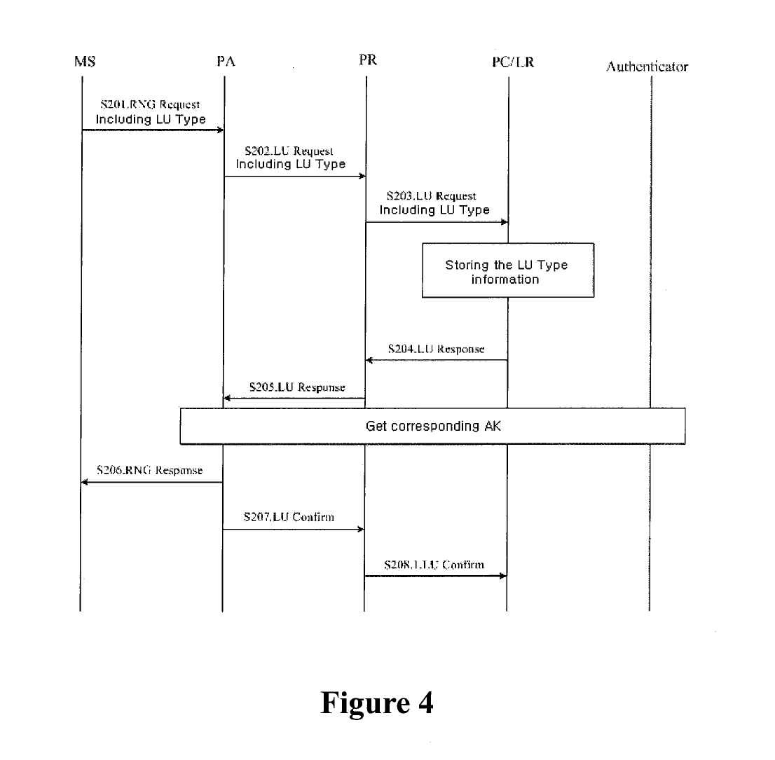

As shown in FIG. 4, it includes the following steps:

S201: In the existing protocol, the RNG Request message carrying LU Flag identification contains MAC Hash Skip Threshold field and Power Down Indicator field, indicating whether or not it is a MAC Hash Skip Threshold update or Power Down update. The RNG Request message also contains the BS ID field, used to indicate the BS on which the MS currently belongs to;

S202: Upon the PA receiving the MS's RNG Request message, it confirms the triggering condition type based on the content therein:

If the MAC Hash Skip Threshold field has been set, which indicates the current type is MAC Hash Skip Threshold update;

If the Power Down Indicator field has been set, which indicates the current type is Power Down update;

If both fields are empty, then the PA cannot judge whether it is a Paging Group update or Timer update. The specific setup example is shown in Table 4 and Table 5.

The extended LU Request message contains the specific message shown in Table 6;

S203: Upon the Paging Relay receiving the LU Request message, it sends a LU Request message to the Anchor PC, according to the PC ID carrying in the message;

S204: Upon the Anchor PC receiving the LU Request message, it records the triggering type information corresponding to the MS ID record based on the information carried in the LU Type flag bit. If the LU Type flag bit is set to 00 as seen in the setup mode in Table 4, then the Anchor PC judges whether the BS ID and the Paging Group information on which the MS belongs to are matching; if it is, then it is a location update triggered by Timer update, otherwise, it is a location update triggered by a Paging Group update. If it is the setup mode described in Table 5, then the Anchor PC may directly confirm the location update type, and the Anchor PC sends a LU Response message to the Paging Relay. The LU Response message must contain MS ID, BS ID, PG ID, Anchor Authenticator's Authenticator ID and PC ID;

S205: the Paging Relay transmits the LU Response message to PA;

Upon PA's BS receiving the LU Response message, it first judges whether there is an available AK from the Anchor Authenticator corresponding to MS ID. If there is no corresponding AK, the PA's BS will send an AK request message to the Anchor Authenticator. The Anchor Authenticator returns an AK response to provide an AK serial number used for establishing a secure connection between BS and MS;

S206: The BS, where the PA is located, uses AK to verify integrity and accuracy of the RNG Request message from MS. If the MS's RNG Request message passes verification, then the BS will reply with a RNG Response (Ranging Response) message to the MS and the RNG Response message carries the newly assigned PG ID. If RNG Request fails verification, then the BS starts the Un-secure Location Update process through initializing re-authentication;

S207: If the RNG_REQUEST message passes verification, the PA sends a LU Confirm (Location Update Confirmation) message to Paging Relay; this LU Confirm message must contain MS ID, BS ID, and authentication success indication, to indicate Location update from MS has already been authenticated and the process has finished successfully.

S208: Paging Relay transmits this LU Confirm message to the Anchor PC, after the Anchor PC receives the LU Confirm message, and it performs a corresponding process based on the MS's current location update type recorded in step S204;

If the location update is triggered by Paging Group update, then update information in LR;

If the location update is triggered by Timer update, then perform the corresponding process;

If the location update is triggered by power-off, then delete all idle mode information regarding to that MS;

If the location update is triggered by the MAC Hash Skip Threshold update, then perform the corresponding process, and the existing protocol will not establish a specific processing method.

In the above described application example, it is only necessary to extend the LU Request message, which enables the Anchor PC to confirm the current location update type and improves the processing location update success rate.

Referencing the RNG Request message, this message has already defined two message units: they are the MAC Hash Skip Threshold field and the Power Down Indicator field, used to indicate the location update type. Then the update type information in LU Request message, LU Response message, and the LU Confirm message can also be indicated by the defined two message units: the MAC Hash Skip Threshold field and the Power Down Indicator field. Among these, the MAC Hash Skip Threshold field indicates the location update request is triggered by MAC Hash Skip Threshold update; the Power Down Indicator field indicates the location update request is triggered by Power Down update. If both fields are empty, then this indicates Timer update or Paging Group update; final judgment will be specifically based on the BS's BS ID on which the MS currently belongs to and the MS's Paging Group information.

Extension of LU request message, LU Response message and LU Confirm message based on this method still can be applied to the above described application example 1 or 2, and the specific information contained in the extended Lu Request message is as shown in Table 9 below:

TABLE 9
Extended LU Request message contents

| Information | | Forced or | |
|---|---|---|---|
| elements | Description | optional | Remarks |
| MS ID | MS's MAC address | Forced | This flag is only the MS |
| | | | sent request |
| BS ID | Base station | Forced | BS ID indicates the BS on |
| | identification | | which the MS was |
| | | | executing location update |
| PC ID | PC identification (for | Forced | PC ID indicates the MS's |
| | example, IP address) | | Paging Controller (Anchor |
| | | | PC) |
| MAC Hash Skip | The maximum number | Optional | The information carried |
| Threshold | of times the BS sending | | when the location update |
| | MOB PAG-ADV | | is triggered by MAC Hash |
| | (Mobile Paging | | Skip Threshold update |
| | Advertisement) | | |
| | message | | |
| Power Down | This information | Optional | The information carried |
| Indicator | indicates the MS is | | when the location update |
| | currently performing a | | is triggered by Power |
| | power-off operation | | Down update |
| Relocation_Dest_ID | Relocation destination | Optional | Identification of the |
| | identification | | intended relocation of |
| | | | Anchor PC |

The specific content of the extended LU Response message is as shown in Table 10:

TABLE 10
The extended LU Response message content

| Information | | Forced or | |
|---|---|---|---|
| elements | Description | optional | Remarks |
| MS ID | MS's MAC address | Forced | This identification is only |
| | | | the sending request MS |
| BS ID | Base station | Forced | BS ID instructs where BS |
| | identification | | is when MS executing |
| | | | location updating |
| PG ID | Paging group | Forced | |
| | identification-The MS | | |
| | assigned paging group | | |
| PC ID | PC identification (for | Forced | PC ID is only the MS's |
| | example, IP address) | | paging controller |
| MAC Hash | The maximum number | Optional | The information carried |
| Skip | of times the BS sending | | when the location update |
| Threshold | MOB PAG-ADV | | is triggered by MAC Hash |
| | (Mobile Paging | | Skip Threshold update |
| | Advertisement) message | | |
| Power Down | This information | Optional | The information carried in |
| Indicator | indicates the MS is | | the message when the |
| | currently performing | | location update is |
| | power-off operation | | triggered by Power Down |
| | | | update |
| MS Security | AKID, AK, PN, AK | Forced | The security context that |
| Context | lifetime | | BS needs to enable BS |
| | | | RNG-REQUEST message. |
| Relocation_Response | (Boolean variable) | Optional | “Accept” or “Refuse” |
| | response relocation | | |
| MS Data | The old Anchor PC | Optional | Attention, if any field |
| Structure | needs to pass | | above is “Refuse”, this |
| | information to the new | | field can be ignored. |
| | Anchor PC. | | |

The specific contents of the extended LU Confirm message is as shown in Table 11:

TABLE 11
The extended LU Confirm message contents

| Infor- | | | |
|---|---|---|---|
| mation | | Forced or | |
| elements | Description | optional | Remarks |
| MS ID | MS's MAC address | Forced | This identification is only |
| | | | the sending request MS |
| BS ID | Base station | Forced | BS ID instructs where |
| | identification | | BS is when MS executes |
| | | | location updating |
| PC ID | PC identification (for | Forced | PC ID is only the MS's |
| | example, IP address) | | paging controller |
| MAC | The maximum number | Optional | The information carried |
| Hash Skip | of times the BS | | in the message when the |
| Threshold | sending MOB | | location update is |
| | PAG-ADV | | triggered by MAC Hash |
| | (Mobile Paging | | Skip Threshold update |
| | Advertisement) | | |
| | message | | |
| Power | This information | Optional | The information carried |
| Down | indicates the MS is | | in the message when the |
| Indicator | currently performing | | location update is |
| | power-off operation | | triggered by Power |
| | | | Down update |
| LU | Location update | Forced | |
| Success/ | success/failure | | |
| Failure | indication | | |
| Indicator | | | |
| Security | Security context | Forced | It may use |
| Context | update | | MS_Security_Context |
| Update | | | |
| Relocation | (Boolean variable) | Optional | Destination relocation |
| Success | indicates whether | | successful |
| Indicator | relocation is being | | |
| | accepted, and finished | | |
| | relocation destination | | |

Of course, if the RNG Request message definitely carries all update type information, without ruling out any indication of the Timer update or Paging Group update information unit directly carrying the LU Request message, LU Response message, or LU Confirm message, thus it can eliminate the steps that the Anchor PC has taken to perform specific judgments according to the BS ID of the BS that the MS currently belongs to and the MS's Paging Group information.

The above described two application examples explain how to implement the technical proposal in the application example of the present invention, based on four location update types defined by the existing protocol. To describe in a precise manner, the technical proposal of the application example of the present invention includes the following two steps:

The Paging Agent sends a location update request to the Paging Controller at the time of the Mobile Station location update, and the location update request carries information indicating the Mobile Station location update type; the Paging Controller performs the corresponding process based on the said indication of the location update type information, after Mobile Station location update is successful.

As can be seen, when the location update type changes, only the corresponding flag bit or information unit needs to be set. This enables the location update type information to be passed over to the PC during location update, which allows the PC to perform the corresponding process based on the specific type in order to achieve the said technical effects of the application example of the present invention. Therefore, the protection scope of the application example of the present invention is not limited to the location update type.

For the purpose of clarification, another application example is described in detail below.

### APPLICATION EXAMPLE 3

When the location update triggered by MAC Hash Skip Threshold is not necessary in the Paging System, that is, the update type includes the following three types: the location update triggered by Paging Group update, location update triggered by timer update, and location update triggered by Power Down Indicator. At this time, if the location update type is carried through the flag bit, taking the RNG Request message as an example, when the specific information of Paging Group update or timer update is not contained in the RNG Request message, and when PA cannot distinguish the Paging Group update or timer update, the flag bit needs the minimum of 1 bit. The specific setup method is shown in Table 12 below:

TABLE 12
LU Type flag bit

| 28. Type | 29. Flag bit (1 bit) | 30. Description |
|---|---|---|
| 31. Type 1 | 32. 0 | 33. Paging Group update |
| | | or timer update |
| 34. Type 2 | 35. 1 | 36. Power-off update |

If the RNG Request message contains the specific information for each type, then the PA can judge all update types; correspondingly, the LU Type flag bit can be set based on Table 13 below:

| 37. Type | 38. Flag bit (2 bits) | 39. Description |
|---|---|---|
| 40. Type 1 | 41. 00 | 42. Paging Group update |
| 43. Type 2 | 44. 01 | 45. Timer update |
| 46. Type 3 | 47. 10 | 48. Power-off update |

If the method described in the application example 1 is applied, it is necessary to extend a LU Type flag bit in the LU Request message, the LU Response message, and the LU Confirm message, respectively; if the method described in the application example 2 is applied, it is only necessary to extend the LU Type flag bit in the LU Request message.

In the same way, while referencing the information unit already defined in the RNG Request, the update type information in the LU Request message, the LU Response message, and the LU Confirm message can be indicated through one information unit: the Power Down Indicator field. The Power Down Indicator therein indicates the location update request is triggered by Power Down update. If this field is empty, which indicates Timer update or Paging Group update, a final judgment will be specifically made by the Anchor PC according to the BS ID of the BS that the MS currently belongs to and the MS's Paging Group information.

The extended LU Request message LU Response message, or LU Confirm message based on this method also can apply the said methods in the application example 1 or 2, and the extended LU Request message includes the specific information as shown in Table 14 below:

TABLE 14
The extended LU Request message contents

| Information | | Forced or | |
|---|---|---|---|
| elements | Description | optional | Remarks |
| MS ID | MS's MAC address | Forced | This flag is only the MS sent |
| | | | request |
| BS ID | Base station | Forced | BS ID indicates the BS on |
| | identification | | which the MS is executing |
| | | | location update |
| PC ID | PC identification (for | Forced | PC ID indicates the MS's |
| | example, IP address) | | Paging Controller (Anchor |
| | | | PC) |
| Power Down | This information | Optional | The information carried |
| Indicator | indicates the MS is | | when the location update is |
| | currently performing | | triggered by Power Down |
| | power-off operation | | update |
| Relocation_Dest_ID | Relocation destination | Optional | Identification of the |
| | identification | | intended relocation of |
| | | | Anchor PC |

The specific contents of the extended LU Response message is as shown in Table 15 below:

TABLE 15
The extended LU Response message content

| Information | | Forced or | |
|---|---|---|---|
| elements | Description | optional | Remarks |
| MS ID | MS's MAC address | Forced | This identification is only |
| | | | the sending request MS |
| BS ID | Base station | Forced | BS ID instructs where BS |
| | identification | | is when MS executing |
| | | | location updating |
| PG ID | Paging group | Forced | |
| | identification-The MS | | |
| | assigned paging group | | |
| PC ID | PC identification (for | Forced | PC ID is only the MS's |
| | example, IP address) | | paging controller |
| Power Down | This information | Optional | The information carried in |
| Indicator | indicates the MS is | | the message when the |
| | currently performing | | location update is |
| | power-off operation | | triggered by Power Down |
| | | | update |
| MS Security | AKID, AK, PN, AK | Forced | The security context that |
| Context | lifetime | | BS needs to enable BS |
| | | | RNG-REQUEST message. |
| Relocation_Response | (Boolean variable) | Optional | “Accept” or “Refuse” |
| | response relocation | | |
| MS Data | The old Anchor PC | Optional | Attention, if any field |
| Structure | needs to pass | | above is “Refuse”, this |
| | information to the new | | field can be ignored. |
| | Anchor PC. | | |

The specific contents of the extended LU Confirm message are as shown in Table 16:

TABLE 16
The extended LU Confirm message contents

| Infor- | | | |
|---|---|---|---|
| mation | | Forced or | |
| elements | Description | optional | Remarks |
| MS ID | MS's MAC address | Forced | This identification is only |
| | | | the sending request MS |
| BS ID | Base station | Forced | BS ID instructs where |
| | identification | | BS is when MS |
| | | | executing location |
| | | | updating |
| PC ID | PC identification | Forced | PC ID is only the MS's |
| | (for example, | | paging controller |
| | IP address) | | |
| Power | This information | Optional | The information carried |
| Down | indicates the MS is | | in the message when the |
| Indicator | currently performing | | location update is |
| | power-off operation | | triggered by Power |
| | | | Down update |
| LU | Location update | Forced | |
| Success/ | success/failure | | |
| Failure | indication | | |
| Indicator | | | |
| Security | Security context | Forced | It may use |
| Context | update | | MS_Security_Context |
| Update | | | |
| Relocation | (Boolean variable) | Optional | Destination relocation |
| Success | indicates whether | | successful |
| Indicator | relocation is being | | |
| | accepted, and finished | | |
| | relocation destination | | |

The application example 3 takes cancellation of the MAC Hash Skip Threshold location update type as an example, and describes the application of the said technical proposal in the application example of the present invention in detail, and the rest may be deduced by analogy for people in the art, when the location update type changes.

In the aforementioned application example, the information unit indicating the MAC Hash Skip Threshold location update type in the RNG Request message can also be canceled correspondingly.

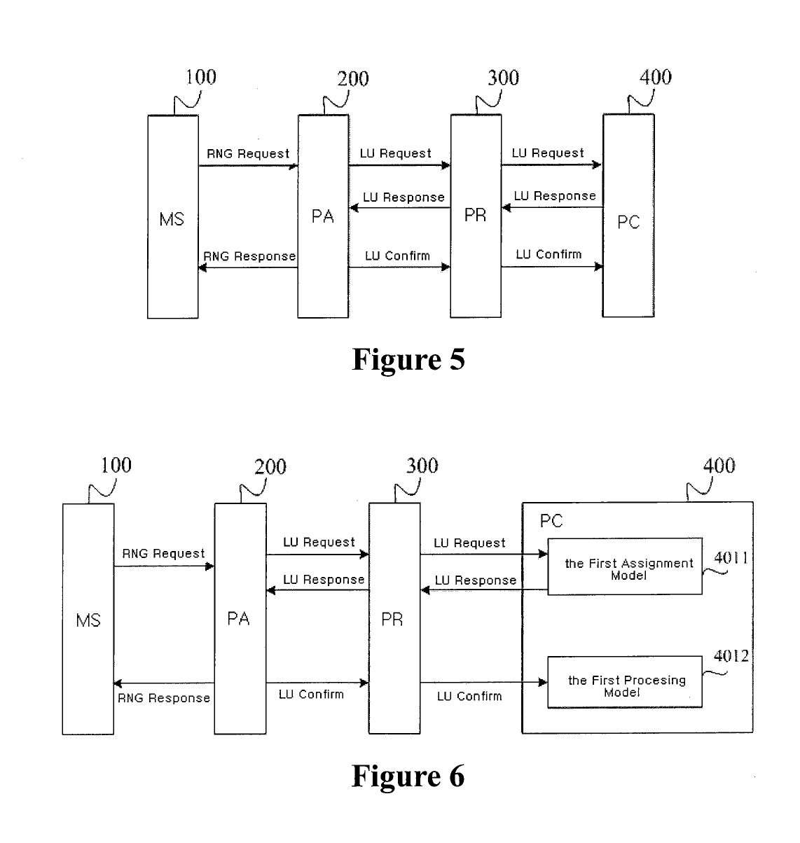

As shown in FIG. 5, the application example of the present invention also provides a Mobile Station location update processing system for implementing the aforementioned Mobile Station location update processing method in a WiMAX system, including a Mobile Station 100, a Paging Agent 200, a Paging Relay 300, and a Paging Controller 400:

The Mobile Station 100 sends a ranging request for execution of location update to the Paging Agent 200 upon carrying out location update, and the ranging request carries information indicating the location update type;

Upon the Paging Agent 200 receiving ranging request, it sends a location update request to the Paging Controller 400 through the Paging Relay 300, and the location update request carries information indicating the location update type;

The Paging Controller 400 performs a corresponding process based on the indication of location update type, after Mobile Station location update is successful.

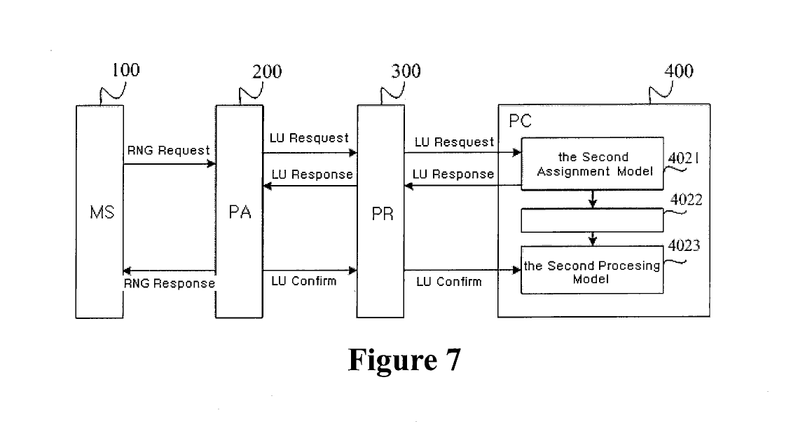

As shown in FIG. 6, based on an implementation method in the application example 1, the Paging Controller 400 is not required to store information indicating the location update type locally, and the Paging Controller 400 includes: the 1st assignment module 4011 and the 1st processing module 4012;

The 1st assignment module 4011 assigns a Paging Group for the Mobile Station 100, upon receiving location update request, and returns a location update response to the Paging Agent 200 through the Paging Relay 300, and the location update response carries information indicating location update type and the assigned Paging Group identification information;

The Paging Agent 200 sends the ranging response message carrying the Paging Group identification information to the Mobile Station 100, and sends location update confirmation to the Paging Controller 400 through the Paging Relay 300, and the location update confirmation contains the information indicating the location update type;

Upon the processing module 4012 receiving location update confirmation, it performs corresponding process based on the information carrying indicating location update type.

As shown in FIG. 7, based on the implementation method in the application example 2, the Paging Controller 400 needs to store the information indicating location update type locally, and the Paging Controller 400 includes: the 2nd assignment module 4021, the storage module 4022, and the 2nd processing module 4023;

Upon the 2nd assignment module 4021 receiving the location update request, it records the information indicating the location update type and stores in the storage module 4022; the 2nd assignment module 4021 assigns the Paging Group for the Mobile Station, then returns a location update response to the Paging Agent 200 through the Paging Relay 300, and the location update response carries the assigned Paging Group identification information;

The Paging Agent 200 sends a ranging response message carrying the Paging Group identification information to the Mobile Station 100, and sends a location update confirmation to the Paging Controller 400 through the Paging Relay 300;

Upon the 2nd processing module 4023 receiving the location update confirmation, perform the corresponding process based on the information indicating the Mobile Station location update type recorded in the storage module 4022.

To avoid repetition, refer to the description of the application example 1, application example 2, and application example 3 for the specific method for extending each message in the aforesaid Mobile Station location update processing system in the application example of the present invention.

Obviously, people in the field may make various changes and modifications of the invention without departing from the essence and scope of invention. Thus, if these changes and modifications of the application example of this invention and claims fall within under the scope of the claim and the same technology, then the application example of the invention is also intended to include these changes and modifications.

1. A method for performing location update in a WiMAX system, the method comprising:
sending a first request from a paging agent to a paging controller for a location update for a mobile station, the request including information with a type of the location update;
processing information based on the type by the paging controller if the location update is successfully performed.

2. The method of claim 1 further comprising:
sending a second request from the mobile station to the paging agent, the second request being associated with a range information and the location update, the range information including the type;
wherein:
the sending a first request comprises receiving the second request by the paging agent, the request including information with a type of the location update.

3. The method of claim 2 further comprising:
assigning the mobile station to a paging group by the paging controller upon receiving the first request;
providing a first response for location update to the paging agent through a paging relay, the first response including information associated with the type and an identification of the paging group;
sending a second response from the paging agent to the mobile station, the second response including a range information and the identification of the paging group;
sending a confirmation from the paging agent to the paging controller through the paging relay, the confirmation being associated with the location update and the type;
performing a corresponding process by the paging controller upon receiving the confirmation, the corresponding process being based on the type.

4. The method of claim 2 further comprising:
storing the type information by the paging controller upon receiving the first request;
assign the mobile station to a paging group by the paging controller;
providing a location update response to the paging agent through a paging relay, the response including an identification associated with the paging group;
sending a range response from the paging agent to the mobile station, the range response including the identification associated with the paging group;
sending a confirmation from the paging agent to the paging controller through the paging relay;
performing a corresponding process by the paging controller upon receiving the confirmation, the corresponding process being based on the type.

5. The method of claim 1 wherein the type is indicated by a flag bit in a location update message.

6. The method of claim 1 wherein the type is location update triggered by a paging group, a location trigger by a timer update, a location update trigger by a power down indication, or a location update trigger by a MAC hash skip threshold.

7. The method of anyone of claim 1 wherein the type is indicated by providing an optional field in a message for the location update.

8. The method of claim 7 wherein the optional filed includes a first field associated with a location update triggered by a power down indicator.

9. The method of claim 7 wherein the type includes location update triggered by MAC Hash Skip Threshold, and the optional field includes a second field indicating the location update being triggered by MAC Hash Skip Threshold.

10. The method claim 8 wherein the type includes location update triggered by MAC Hash Skip Threshold, and the optional field includes a second field indicating the location update being triggered by MAC Hash Skip Threshold.

11. The method of claim 8 wherein:
the type includes location update triggered by paging group update date or location update triggered by a timer update;
when the first field and the second filed are null, the paging controller determines whether a based station serving the mobile station currently belongs to a paging group, the paging group being associated with the mobile station;
triggering a location update by the timer update if the base station and the mobile stations are associated with a same paging group;
triggering a location update by the paging controller if the base station and the mobile stations are not associated with a same paging group.

12. The method of claim 9 wherein:
the type includes a location update triggered by a paging group update;
the optional field includes a third information field for the location update triggered by the paging group update;
the type includes location update triggered by timer update;
the optional field includes a fourth field including a location update triggered by the timer update.

13. A system for providing location update for one or more mobile stations in a WiMAX network, the system comprising:
a mobile station;
a paging agent configured to performing location update for a mobile station;
a paging controller configured to performing a process based on information associated with a location update type after a successful location update by the mobile station.
wherein:
the paging agent send s a location update request to the paging controller, the location update request including the location update type.

14. The system of claim 13 further comprising a paging relay, wherein:
the mobile station sends a ranging request for performing a location update to the paging agent for the location update, the ranging request including information indicating the location update type;
the paging agent sends the location update request upon receiving the ranging request through the paging relay, the location update request including information associated with the location update type.

15. The system of claim 14 wherein:
the paging controller includes a first assignment module and a first processing module;
the assignment module is configured to assign a paging group to the mobile station and provide a location update response to the paging agent through the paging relay upon receiving the location update request, the location update response including information associated with the type and an identification of the paging group;
the paging agent is configured to sends a ranging response message to the mobile station, the ranging response including the identification of the paging group;
the paging agent is further configured to send a confirmation to the paging controller through the paging relay, the confirmation including information associated the location update type;
the first processing module, upon receiving the location update confirmation, performs a process based on the location update type.

16. The system of claim 14 wherein:
the paging controller includes a second assignment module, a storage module, and a second processing module;
the second assignment module is configured to record information associated with the location update to the storage module upon receiving the location update request;
the second assignment module is further configured to assign a mobile station to a paging group and to provide a location update response to the paging agent through the paging relay, the location update including an identification for the paging group;
the paging agent is further configured to send a confirmation to the paging controller through the paging relay, the confirmation including information associated the location update type;
the second processing module, upon receiving the location update confirmation, performs a process based on the location update type.
